(19) United States
(12) Patent Application Publication
(10) Pub. No.: US 2023/0309114 A1
(43) Pub. Date: Sep. 28, 2023

(54) METHOD AND DEVICE FOR PROCESSING DOWNLINK CONTROL INFORMATION

(71) Applicant: Beijing Unisoc Communications Technology Co., Ltd., Beijing (CN)

(72) Inventor: Huan Zhou, Beijing (CN)

(21) Appl. No.: 18/040,811

(22) PCT Filed: Jul. 8, 2021
(86) PCT No.: PCT/CN2021/105251

§ 371 Date: Feb. 6, 2023

(30) Foreign Application Priority Data
Aug. 6, 2020 (CN) 202010783576.5

(51) Int. Cl. H04W 72/232; H04W 72/12

(52) U.S. Cl. CPC H04W 72/232; H04W 72/12

(57) ABSTRACT

Embodiments of the present disclosure provides a method for processing downlink control information, including: receiving, by a UE, DCI sent by a network device; determining a first serving cell according to a CIF value in the DCI, and determining a target serving cell scheduled by the DCI according to a configuration parameter of the first serving cell, where the configuration parameter includes one or more serving cell indexes; or, determining, according to codepoint information corresponding to a target bitfield in the DCI, scheduling information of the target serving cell scheduled by the DCI, where the codepoint information corresponding to the target bitfield in the DCI is used to indicate scheduling information of one or more schedulable serving cells.

This application is a continuation of International Application No. PCT/CN2021/105251, filed on Jul. 8, 2021, which claims priority to Chinese patent application No. 202010783576.5, filed with the China National Intellectual Patent Administration on Aug. 6, 2020, entitled “METHOD AND DEVICE FOR PROCESSING DOWNLINK CONTROL INFORMATION”, both of which are hereby incorporated by reference in their entireties.

### TECHNICAL FIELD

The present disclosure relates to the technical field of communication, and in particular, to a method and device for processing downlink control information (DCI).

### BACKGROUND

In a new radio (NR) system, DCI usually includes resource allocation information used to inform a user equipment (UE) of a resource location of a serving cell.

The NR system supports carrier aggregation (CA) technology. In a carrier aggregation scenario, the user equipment UE can configure a primary serving cell PCell (Primary Cell, PCell) and a plurality of secondary serving cells (Secondary Cell, SCell), and a network device uses DCI to indicate a serving cell scheduled by the UE. The NR system supports that one DCI can contain scheduling information of a plurality of serving cells at the same time, so as to schedule the plurality of serving cells at the same time.

### SUMMARY

Embodiments of the present disclosure provide a method and device for processing downlink control information.

In a first aspect, an embodiment of the present disclosure provides a method for processing downlink control information, applied to a network device and including:
determining one or more target serving cells scheduled by DCI;
in response to multiple target serving cells being scheduled, configuring codepoint information corresponding to a target bitfield of the DCI, wherein the codepoint information is used to indicate scheduling information of the multiple target serving cells;
sending the DCI to a UE.

In a second aspect, an embodiment of the present disclosure provides a network device, including: at least one processor and a memory;
where the memory is configured to store a computer-executable instruction; and
the at least one processor is configured to execute the computer-executable instruction stored in the memory to cause the at least one processor to:
determine one or more target serving cells scheduled by DCI;
in response to multiple target serving cells being scheduled, configure codepoint information corresponding to a target bitfield of the DCI, wherein the codepoint information is used to indicate scheduling information of the multiple target serving cells;
send the DCI to a UE.

In a third aspect, an embodiment of the present disclosure provides a non-transitory computer readable storage medium, storing a computer-executable instruction, where at least one processor, when executing the computer-executable instruction, is configured to:
determine one or more target serving cells scheduled by DCI;
   in response to multiple target serving cells being scheduled, configure codepoint information corresponding to a target bitfield of the DCI, wherein the codepoint information is used to indicate scheduling information of the multiple target serving cells;
   send the DCI to a UE.

According to the method and device for processing downlink control information provided by the embodiments of the present disclosure, when DCI needs to schedule a plurality of serving cells at the same time, a network device can configure serving cell indexes of a plurality of serving cells in a configuration parameter of a first serving cell scheduled by the DCI at the same time, and without a DCI format needing to be changed, the UE is enabled to, after receiving the DCI, accurately parse the plurality of serving cells scheduled by the DCI according to the configuration parameter of the first serving cell; or, when the DCI needs to schedule the plurality of serving cells at the same time, the network device can configure codepoint information corresponding to a target bitfield in the DCI, the configured codepoint information can be used to indicate scheduling information of one or more schedulable serving cells, thereby without the DCI format needing to be changed, the UE is enabled to, after receiving the DCI, accurately parse the scheduling information of the plurality of serving cells scheduled by the DCI according to the codepoint information corresponding to the target bitfield in the DCI.

### BRIEF DESCRIPTION OF DRAWINGS

In order to more clearly describe the embodiments of the present disclosure or the technical solution in the related art, the drawings needed to be used in the description of the embodiments or the related art will be briefly introduced below. Obviously, the drawings in the following description are some embodiments of the present disclosure, and for those of ordinary skills in the art, other drawings can be obtained according to these drawings without making creative efforts.

FIG. 1 is a schematic architectural diagram of a wireless communication system provided by an embodiment of the present disclosure.

FIG. 2 is a first schematic flowchart of a method for processing downlink control information provided by an embodiment of the present disclosure.

FIG. 3 is a second schematic flowchart of a method for processing downlink control information provided by an embodiment of the present disclosure.

FIG. 4 is a third schematic flowchart of a method for processing downlink control information provided by an embodiment of the present disclosure.

FIG. 5 is a first schematic signaling diagram of a method for processing downlink control information provided by an embodiment of the present disclosure.

FIG. 6 is a fourth schematic flowchart of a method for processing downlink control information provided by an embodiment of the present disclosure.

FIG. 7 is a second schematic signaling diagram of a method for processing downlink control information provided by an embodiment of the present disclosure.

FIG. 8 is a first schematic diagram of a program module of an apparatus for processing downlink control information provided by an embodiment of the present disclosure.

FIG. 9 is a second schematic diagram of a program module of an apparatus for processing downlink control information provided by an embodiment of the present disclosure.

FIG. 10 is a schematic hardware structural diagram of an electronic device provided by an embodiment of the present disclosure.

### DESCRIPTION OF EMBODIMENTS

In order to make the purpose, technical solution and advantages of the embodiments of the present disclosure clearer, the technical solution in the embodiments of the present disclosure will be clearly and completely described below with reference to the drawings in the embodiment of the present disclosure. Obviously, the described embodiments are part of the embodiments of the present disclosure, but not all of the embodiments. Based on the embodiments of the present disclosure, all other embodiments obtained by those of ordinary skills in the art without making creative efforts belong to the protection scope of the present disclosure.

The embodiments of the present disclosure can be applied to various communication systems, such as a global system of mobile communication (GSM) system, a code division multiple access (CDMA) system, a wideband code division multiple access (WCDMA) system, a general packet radio service (GPRS), a long term evolution LTE) system, an advanced long-term evolution (LTE-A) system, a new radio (NR) system, an evolution system of the NR system, an LTE-based access to unlicensed spectrum (LTE-U) system, an NR-based access to unlicensed spectrum (NR-U) system, a universal mobile telecommunication system (UMTS), a wireless local area network (WLAN), a wireless fidelity (WiFi), a next generation communication systems or other communication systems.

Generally speaking, the number of connections supported by traditional communication systems is limited, and is easy to be realized. However, with the development of communication technology, mobile communication systems will not only support traditional communication, but also support, for example, device to device (D2D) communication, machine to machine (M2M) communication, machine type communication (MTC), vehicle-to-vehicle (V2V) communication, etc. The embodiments of the present disclosure can also be applied to these communication systems.

In an embodiment, the communication system in the embodiment of the present disclosure can be applied to a carrier aggregation (CA) scenario, a dual connectivity (DC) scenario, and a standalone (SA) network deployment scenario.

The embodiments of the present disclosure do not limit an applied frequency spectrum. For example, the embodiments of the present disclosure can be applied to both licensed spectrum and unlicensed spectrum.

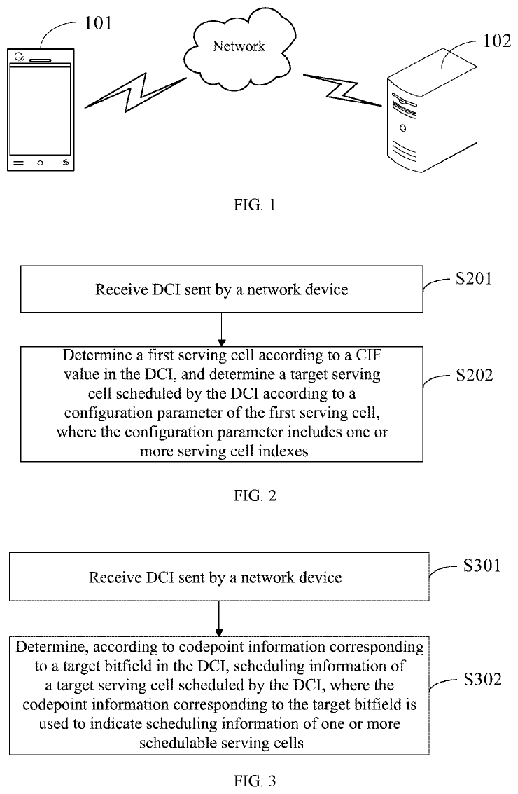

Referring to FIG. 1, FIG. 1 is a schematic architectural diagram of a wireless communication system provided by an embodiment of the present disclosure. The wireless communication system provided by the present embodiment includes a UE 101 and a network device 102.

In an embodiment, UE 101 may refer to various forms of user equipments, access terminals, user units, user stations, mobile platforms, mobile stations (MS), remote stations, remote terminals, mobile devices, terminal equipment, wireless communication devices, user agents or user apparatuses. It can also be a cellular phone, a cordless phone, a session initiation protocol (SIP) phone, a wireless local loop (WLL) station, a personal digital assistant (PDA), a handheld device with wireless communication function, a computing device or other processing devices, vehicle-mounted devices and wearable devices connected to wireless modems, a terminal device in future fifth generation (5G) network or a terminal device in future evolved public land mobile network (PLMN), etc., which are not limited in the embodiments of the present disclosure, as long as the UE 101 can communicate wirelessly with the network device 102.

The embodiment of the present disclosure defines a unidirectional communication link from the access network to the UE as downlink (DL), where data transmitted on the downlink is downlink data, and a transmission direction of the downlink data is referred to as a downlink direction; and defines a unidirectional communication link from the UE to the access network as uplink (UL), where data transmitted on the uplink is uplink data, and a transmission direction of the uplink data is referred to as an uplink direction.

In an embodiment, the network device 102, that is, the public mobile communication network device, is an interface device for the UE 101 to access the Internet, and is also a form of radio station, which refers to a radio transceiver station that communicates information with the UE 101 in a certain radio coverage area, including a base station (BS), which can also be referred to as a base station device, which is an apparatus deployed in a radio access network (RAN) to provide wireless communication functions. For example, devices that provide base station functions in a second generation (2G) network include a base transceiver station (BTS), devices that provide base station functions in a third generation (3G) network include a Node B (NodeB), and devices that provide base station functions in a fourth generation (4G) network include an evolved Node B (evolved NodeB, eNB). In a wireless local area network (WLAN), devices that provide base station functions is an access point (AP), and devices that provide base station functions in 5G NR is a next generation Node B (gNB) and a continuing evolved Node B (ng-eNB), where the gNB and UE communicate by adopting NR technology, and the ng-eNB and UE communicate by adopting an evolved universal terrestrial radio access (E-UTRA) technology, and both gNB and ng-eNB can be connected to a 5G core network. The network device 102 in the embodiment of the present disclosure also includes devices that provide base station functions in future new communication systems.

In a possible implementation, the network device can send uplink scheduling information (UL Grant) to the UE through downlink control information (DCI), which indicates a uplink physical shared channel (PUSCH) transmission, so that the UE can send data.

In an embodiment, the UL grant can include the following information:
resource assignment information (Resource block assignment and hopping resource allocation);
modulation and coding scheme and redundancy version information: used to specify a modulation and coding scheme (MCS) and a redundancy version (RV) of the corresponding PUSCH transmission, and also used to determine a transmission block (TB) size;
new data indicator: used to determine whether the current transmission is a new transmission or a retransmission; and
a transmission control protocol (TPC) command for scheduling PUSCH: used for power control of the PUSCH.

In addition, for uplink transmission, there are usually two types of pre-configuration/semi-static resource (configured grant resource) configuration manners:
pre-configuration (pre-grant) manner 1: configuring through a signaling of a radio resource control (RRC) layer (IE Configured Grant Config); and
pre-configuration (pre-grant) manner 2: the DCI indicates activation and deactivation of uplink pre-configuration/semi-static resources, where a part of configuration parameters required by the DCI are configured by the IE Configured Grant Config, but they need to be activated by the DCI before they can be used.

In an embodiment, the embodiment of the present disclosure can be applied to all kinds of periodic services, and the network device can configure periodic transmission resources for the UE by adopting a manner of semi-persistent scheduling (SPS) or pre-configuration/pre-grant (Configured Grant, CG).

In an embodiment, the embodiment of the present disclosure can also be applied to aperiodic services.

In a communication system in which carrier aggregation is introduced, the aggregated carrier is referred to as a component carrier (CC), also referred to as a serving cell, including a primary component carrier/cell (PCC/PCell) and a secondary component carrier/cell (SCC/SCell). In a communication system with carrier aggregation, there is at least one primary serving cell and at least one secondary serving cell, where the primary serving cell is always in an active state.

At present, UE can configure a primary serving cell PCell and a plurality of secondary serving cells SCells, and the network device indicates the serving cells to be scheduled by UE through the DCI. One DCI may include scheduling information of one certain serving cell, or may include scheduling information of a plurality of serving cells at the same time. However, when the DCI needs to schedule the plurality of serving cells at the same time, how to enable the UE to accurately parse the serving cells scheduled by the DCI without changing a DCI format remains to be solved.

To address the above technical problems, embodiments of the present disclosure provide a method and device for processing downlink control information, when DCI needs to schedule a plurality of serving cells at the same time, a network device can configure serving cell indexes of a plurality of serving cells in a configuration parameter of a first serving cell scheduled by the DCI at the same time, and after receiving the DCI, the UE parses the plurality of serving cells scheduled by the DCI according to the configuration parameter of the first serving cell; or, the network device can configure codepoint information corresponding to a target bitfield in the DCI, the configured codepoint information can be used to indicate scheduling information of one or more schedulable serving cells, and after receiving the DCI, the UE parses the scheduling information of the plurality of serving cells scheduled by the DCI according to the codepoint information corresponding to the target bitfield in the DCI. Please refer to the following embodiments of the present disclosure for details.

Referring to FIG. 2, FIG. 2 is a first schematic flowchart of a method for processing downlink control information provided by an embodiment of the present disclosure. An executive subject of the present embodiment is the UE in the embodiment shown in FIG. 1. As shown in FIG. 2, the method includes:
S201, a UE receives DCI sent by a network device.

In the embodiment of the present disclosure, cross-carrier scheduling can be realized, that is, a physical downlink control channel (PDCCH) on a certain serving cell can schedule physical downlink shared channels (PDCCH)/physical uplink shared channels (PUSCH) of a plurality of serving cells. A serving cell where the PDCCH belongs to is referred to as a serving cell scheduled by this carrier, and a serving cell where the PDCCH/PUSCH belongs to is referred to as a scheduled service cell.

In the embodiment of the present disclosure, before the network device sends the DCI to the UE, the network device can first configure a schedulable serving cell that can be scheduled by the UE through radio resource control (RRC) high-level signaling, and then configure indication information in the DCI to be sent, where the indication information is used to indicate a first serving cell scheduled by the UE. Exemplary, the indication information may be a carrier indicator field (CIF) value, a bitmap value, a search space identifier (search space ID), etc.

In an embodiment, the above DCI can be used to schedule one serving cell, or a plurality of serving cells at the same time. When the DCI is used to schedule a plurality of serving cells, the network device can add serving cell indexes (ServCellIndex) of other serving cells to be scheduled in addition to the first serving cell in a high-layer parameter (cross carrier scheduling) of the first serving cell.

For example, when the DCI is used to schedule serving cell 1 and serving cell 2, the network device can configure a CIF value in the DCI to be the same as a CIF value of the serving cell 1, and add a serving cell index of the serving cell 2 to a configuration parameter of the serving cell 1. Therefore, two serving cells can be scheduled at the same time by means of one CIF value, and a length of the DCI for scheduling one serving cell is the same as that for scheduling two serving cells.

In an embodiment, the serving cell 1 is a primary scheduled cell in the two serving cells, and the serving cell 2 is a secondary scheduled cell in the two serving cells.

S202, the UE determines a first serving cell according to a CIF value in the DCI, and determines a target serving cell scheduled by the DCI according to a configuration parameter of the first serving cell, where the configuration parameter includes one or more serving cell indexes.

In the embodiment of the present disclosure, after parsing the CIF value in the DCI, the UE can find out the first serving cell scheduled by the DCI according to the CIF value corresponding to each schedulable serving cell.

In a possible implementation, a schedulable serving cells in the respective schedulable serving cells that have a CIF value same as the CIF value in the DCI is determined as the first serving cell.

Further, after the first serving cell is determined, the configuration parameter of the first serving cell is parsed, and if other target serving cell indexes exist in the configuration parameter of the first serving cell in addition to the serving cell index of the first serving cell, the first serving cell and a schedulable serving cell corresponding to the target serving cell index are determined as the target serving cell scheduled by the DCI; and if no other target serving cell index exist in the configuration parameter of the first serving cell in addition to the serving cell index of the first serving cell, the first serving cell is determined as the target serving cell scheduled by the DCI.

For example, when it is determined that the first serving cell is the serving cell 1, it is detected whether there is other target serving cell indexes in the configuration parameter of the serving cell 1 in addition to a serving cell index of the service cell 1, and if a serving cell index of the serving cell 2 exists in the configuration parameter of the serving cell 1, it indicates that the DCI schedules the serving cell 1 and the serving cell 2 at the same time; if no other serving cell index exist in the configuration parameter of the serving cell 1 in addition to the serving cell index of the serving cell 1, it indicates that the DCI only schedules the serving cell 1.

According to the method for processing downlink control information provided by the embodiment of the present disclosure, when DCI needs to schedule a plurality of serving cells at the same time, a network device can configure serving cell indexes of a plurality of serving cells in a configuration parameter of a first serving cell scheduled by the DCI at the same time, and without a DCI format needing to be changed, the UE is enabled to, after receiving the DCI, accurately parse the plurality of serving cells scheduled by the DCI according to the configuration parameter of the first serving cell.

Based on the content described in the above embodiment, referring to FIG. 3, FIG. 3 is a second schematic flowchart of a method for processing downlink control information provided by an embodiment of the present disclosure. An executive subject of the present embodiment is the UE in the embodiment shown in FIG. 1. As shown in FIG. 3, in another possible embodiment of the present disclosure, the above method for processing downlink control information includes:
S301, a UE receives DCI sent by a network device.

In the embodiment of the present disclosure, before sending the DCI to the UE, the network device can first determine a target serving cell scheduled by the DCI, and when the DCI needs to schedule a plurality of serving cells, the network device configures codepoint information corresponding to a target bitfield of the DCI, so that one piece of codepoint information can indicate scheduling information of a plurality of schedulable serving cells.

In addition, the network device also needs to configure configuration information corresponding to the respective schedulable serving cells, where the configuration information includes a scheduling relationship between the codepoint information corresponding to the target bitfield in the DCI and the respective schedulable serving cells; where the codepoint information corresponding to the target bitfield includes first indication information and second indication information, and the number of serving cells indicated to be scheduled by the first indication information and the second indication information are different.

For example, the first indication information may indicate to schedule only one serving cell, while the second indication information may indicate to schedule two serving cells.

S302, the UE determines, according to codepoint information corresponding to a target bitfield in the DCI, scheduling information of a target serving cell scheduled by the DCI, where the codepoint information corresponding to the target bitfield is used to indicate scheduling information of one or more schedulable serving cells.

In the embodiment of the present disclosure, after receiving the DCI, the UE parses the codepoint information corresponding to the target bitfield in the DCI, and when the codepoint information corresponding to the target bitfield is the first indication information, the UE determines a serving cell indicated to be scheduled by the first indication information as the target serving cell scheduled by the DCI; and when the codepoint information corresponding to the target bitfield is the second indication information, the serving cell indicated to be scheduled by the second indication information is determined as the target serving cell scheduled by the DCI.

Exemplary, referring to Table 1, Table 1 is a schematic table of a scheduling relationship between the codepoint information corresponding to the target bitfield in the DCI and the respective schedulable serving cells in the embodiment of the present disclosure.

TABLE 1
a schematic table of a scheduling relationship between
the codepoint information corresponding to the target
bitfield and the respective schedulable serving cells

| DCI bitfield | Size (bits) | Codepoint information | | |
|---|---|---|---|---|
| Virtual resource | 0 or 1 | Index | Cell 0 | Cell 1 |
| block-to-physical resource | | 0 | 0 | 1 |
| block mapping | | 1 | 1 | 1 |
| Physical resource block | 0 or 1 | Index | Cell 0 | Cell 1 |
| bundling size indicator | | 0 | 0 | 1 |
| | | 1 | 1 | 1 |

Exemplary, in Table 1, the target bitfield in the DCI includes a virtual resource block (VRB)-to-physical resource block (PRB) mapping (VRB-to-PRB mapping), and a PRB bundling size indicator (PRB bundling size indicator for short) with a length of 0 or 1 bit.

For bitfield VRB-to-PRB mapping, one codepoint may correspond to scheduling information VRB-PRB mapping of serving cell 0 and serving cell 1. When an index in the codepoint information is 0, it indicates that the DCI only includes scheduling information VRB-to-PRB mapping of the serving cell 1; and when the index in the codepoint information is 1, it indicates that the DCI includes both scheduling information VRB-to-PRB mapping of the serving cell 0 and scheduling information VRB-to-PRB mapping of the serving cell 1.

For the bitfield PRB bundling size indicator, when both the serving cell 0 and the serving cell 1 are configured as dynamic bundling, one codepoint can correspond to scheduling information PRB bundling size indicator of the serving cell 0 and the serving cell 1. When an index in the codepoint information is 0, it indicates that the DCI only includes scheduling information PRB bundling size indicator of the serving cell 1; and when the index in the codepoint information is 1, it indicates that the DCI includes both scheduling information PRB bundling size indicator of the serving cell 0 and scheduling information PRB bundling size indicator of the serving cell 1.

According to the method for processing downlink control information provided by the embodiments of the present disclosure, when the DCI needs to schedule a plurality of serving cells at the same time, the network device can configure codepoint information corresponding to a target bitfield in the DCI, the configured codepoint information can be used to indicate scheduling information of one or more schedulable serving cells, thereby without the DCI format needing to be changed, the UE is enabled to, after receiving the DCI, accurately parse the scheduling information of the plurality of serving cells scheduled by the DCI according to the codepoint information corresponding to the target bitfield in the DCI.

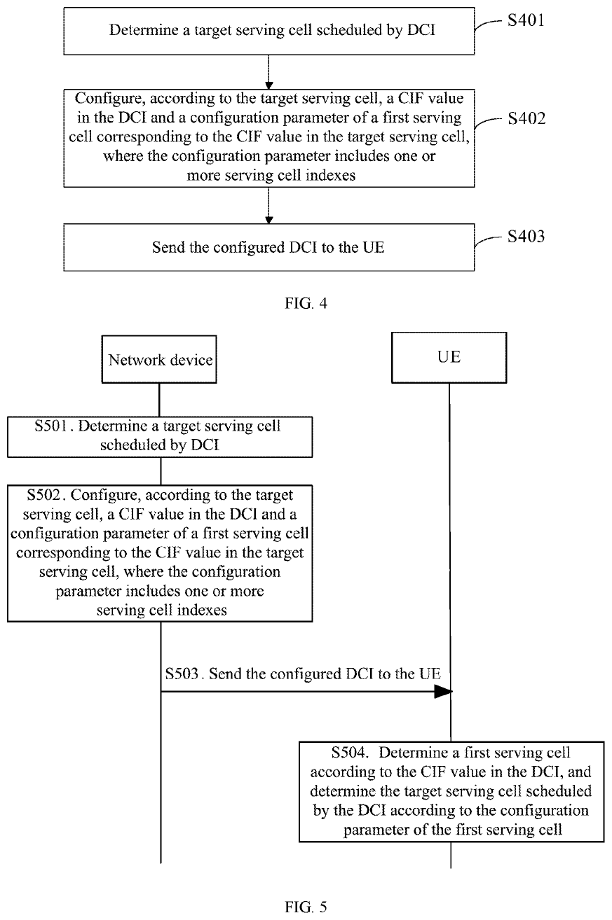

Based on the content described in the above embodiment, referring to FIG. 4, FIG. 4 is a third schematic flowchart of a method for processing downlink control information provided by an embodiment of the present disclosure. An executive subject of the present embodiment is the network device in the embodiment shown in FIG. 1. As shown in FIG. 4, in another possible embodiment of the present disclosure, the above method for processing downlink control information includes:
S401, a network device determines a target serving cell scheduled by DCI;
S402, the network device configures, according to the target serving cell, a CIF value in the DCI and a configuration parameter of a first serving cell corresponding to the CIF value in the target serving cell, where the configuration parameter includes one or more serving cell indexes; and
S403, the network device sends the configured DCI to the UE.

In the embodiment of the present disclosure, before the network device sends the DCI to the UE, the network device can first determine the target serving cell scheduled by the DCI, and configure a schedulable serving cell that can be scheduled by the UE through an RRC high-level signaling, and then configure the CIF value in the DCI to be sent, where the CIF value is used to indicate the first serving cell scheduled by the UE.

In an embodiment, the above DCI can be used to schedule one serving cell, or a plurality of serving cells at the same time. When the DCI is used to schedule a plurality of serving cells, the network device can add serving cell indexes of other serving cells to be scheduled in addition to the first serving cell in a high-layer parameter of the first serving cell.

For example, when the DCI is used to schedule serving cell 1 and serving cell 2, the network device can configure a CIF value in the DCI to be the same as a CIF value of the serving cell 1, and add a serving cell index of the serving cell 2 to a configuration parameter of the serving cell 1.

In a possible implementation, the above step S402 specifically includes:
the network device determines a CIF value corresponding to the first serving cell in the target serving cell; and configures the CIF value in the DCI according to the CIF value corresponding to the first serving cell in the target serving cell, and configures the configuration parameter of the first serving cell according to the number of the target serving cell.

The network device configuring the configuration parameter of the first serving cell according to the number of the target serving cell includes:
when other serving cells exist in the target serving cell in addition to the first serving cell, the network device adds a serving cell index of the other serving cells in addition to the first serving cell to the configuration parameter of the first serving cell.

It can be understood that the method for processing downlink control information described in the above embodiments can be referred to the description of each embodiment in the above method for processing downlink control information applied to the UE, and will not be repeated here.

For better understanding of the embodiment of the present disclosure, referring to FIG. 5, FIG. 5 is a first schematic signaling diagram of a method for processing downlink control information provided by an embodiment of the present disclosure, the above method includes:
S501, a network device determines a target serving cell scheduled by DCI;
S502, the network device configures, according to the target serving cell, a CIF value in the DCI and a configuration parameter of a first serving cell corresponding to the CIF value in the target serving cell, where the configuration parameter includes one or more serving cell indexes;
S503, the network device sends the configured DCI to a UE; and
S504, the UE determines a first serving cell according to the CIF value in the DCI, and determines the target serving cell scheduled by the DCI according to the configuration parameter of the first serving cell.

According to the method for processing downlink control information provided by the embodiments of the present disclosure, when DCI needs to schedule a plurality of serving cells at the same time, a network device can configure serving cell indexes of a plurality of serving cells in a configuration parameter of a first serving cell scheduled by the DCI at the same time, and without a DCI format needing to be changed, the UE is enabled to, after receiving the DCI, accurately parse the plurality of serving cells scheduled by the DCI according to the configuration parameter of the first serving cell.

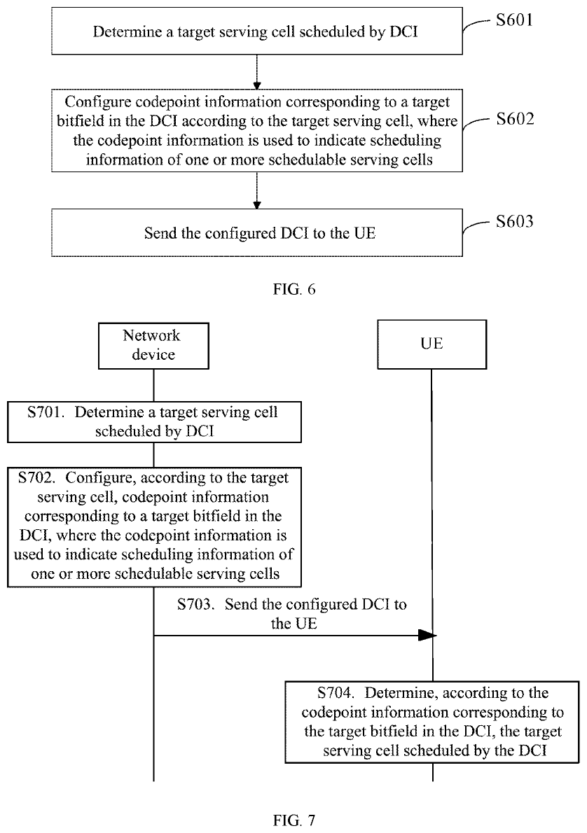

Based on the content described in the above embodiment, referring to FIG. 6, FIG. 6 is a fourth schematic flowchart of a method for processing downlink control information provided by an embodiment of the present disclosure. An executive subject of the present embodiment is the network device in the embodiment shown in FIG. 1. As shown in FIG. 6, in another possible embodiment of the present disclosure, the above method for processing downlink control information includes:
S601, a network device determines a target serving cell scheduled by DCI;
S602, the network device configures codepoint information corresponding to a target bitfield in the DCI according to the target serving cell, where the codepoint information is used to indicate scheduling information of one or more schedulable serving cells; and
S603, the network device sends the configured DCI to the UE.

In the embodiment of the present disclosure, before sending the DCI to the UE, a network device first determines the target serving cell scheduled by the DCI, and when the DCI needs to schedule a plurality of serving cells, the network device configures codepoint information corresponding to a target bitfield of the DCI, so that respective codepoints may include scheduling information of one or more schedulable serving cells.

In addition, the network device also needs to configure configuration information corresponding to the respective schedulable serving cells, where the configuration information includes a scheduling relationship between the codepoint information corresponding to the target bitfield in the DCI and the respective schedulable serving cells; where the codepoint information corresponding to the target bitfield includes first indication information and second indication information, and the number of serving cells indicated to be scheduled by the first indication information and the second indication information are different.

For example, the first indication information may indicate to schedule only one serving cell, while the second indication information may indicate to schedule two serving cells.

It can be understood that the method for processing downlink control information described in the above embodiments can be referred to the description of each embodiment in the above method for processing downlink control information applied to the UE, and will not be repeated here.

For better understanding of the embodiment of the present disclosure, referring to FIG. 7, FIG. 7 is a second schematic signaling diagram of a method for processing downlink control information provided by an embodiment of the present disclosure, the above method includes:
S701, a network device determines a target serving cell scheduled by DCI;
S702, the network device configures, according to the target serving cell, codepoint information corresponding to a target bitfield in the DCI, where the codepoint information is used to indicate scheduling information of one or more schedulable serving cells;
S703, the network device sends the configured DCI to a UE; and
S704, the UE determines, according to the codepoint information corresponding to the target bitfield in the DCI, the target serving cell scheduled by the DCI.

According to a method for processing downlink control information provided by the embodiment of the present disclosure, when the DCI needs to schedule a plurality of serving cells at the same time, the network device can configure codepoint information corresponding to a target bitfield in the DCI, the configured codepoint information can be used to indicate scheduling information of one or more schedulable serving cells, thereby without the DCI format needing to be changed, the UE is enabled to, after receiving the DCI, accurately parse the scheduling information of the plurality of serving cells scheduled by the DCI according to the codepoint information corresponding to the target bitfield in the DCI.

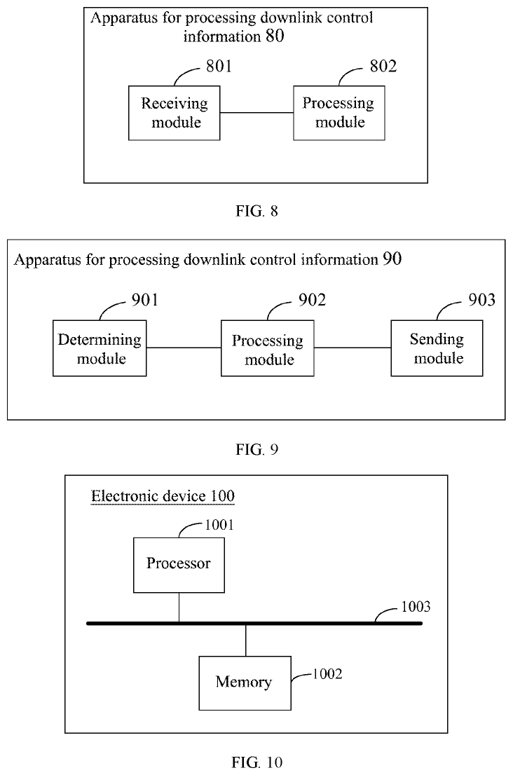

Based on the content described in the above embodiments, referring to FIG. 8, FIG. 8 is a first schematic diagram of a program module of an apparatus for processing downlink control information provided by an embodiment of the present disclosure. An executive subject of the present embodiment is the UE in the embodiment shown in FIG. 1. As shown in FIG. 8, in another possible embodiment of the present disclosure, the above apparatus 80 for processing downlink control information includes:
a receiving module 801, configured to receive DCI sent by a network device; and
a processing module 802, configured to determine a first serving cell according to a CIF value in the DCI, and determine a target serving cell scheduled by the DCI according to a configuration parameter of the first serving cell, where the configuration parameter includes one or more serving cell indexes; or, determine, according to codepoint information corresponding to a target bitfield in the DCI, scheduling information of the target serving cell scheduled by the DCI, where the codepoint information corresponding to the target bitfield is used to indicate scheduling information of one or more schedulable serving cells.

According to the apparatus 80 for processing downlink control information provided by the embodiments of the present disclosure, when DCI needs to schedule a plurality of serving cells at the same time, a network device can configure serving cell indexes of a plurality of serving cells in a configuration parameter of a first serving cell scheduled by the DCI at the same time, and without a DCI format needing to be changed, the UE is enabled to, after receiving the DCI, accurately parse the plurality of serving cells scheduled by the DCI according to the configuration parameter of the first serving cell.

In a possible implementation, the processing module 802 is configured to:
determine a schedulable serving cell in the respective schedulable serving cells that have a CIF value same as the CIF value in the DCI as the first serving cell.

In a possible implementation, the processing module 802 is configured to:
detect whether other target serving cell indexes exist in the configuration parameter of the first serving cell in addition to a serving cell index of the first serving cell;
if other target serving cell indexes exist in the configuration parameter of the first serving cell in addition to the serving cell index of the first serving cell, determine the first serving cell and a schedulable serving cell corresponding to the target serving cell index as the target serving cell scheduled by the DCI; and
if no other target serving cell index exist in the configuration parameter of the first serving cell in addition to the serving cell index of the first serving cell, determine the first serving cell as the target serving cell scheduled by the DCI.

In a possible implementation, the processing module 802 is configured to:
determine configuration information corresponding to the respective schedulable serving cells, where the configuration information includes a scheduling relationship between the codepoint information corresponding to the target bitfield in the DCI and the respective schedulable serving cells; where the codepoint information corresponding to the target bitfield includes first indication information and second indication information, and the number of serving cells indicated to be scheduled by the first indication information and the second indication information are different.

In a possible implementation, the processing module 802 is configured to:
when the codepoint information corresponding to the target bitfield is the first indication information, determine a serving cell indicated to be scheduled by the first indication information as the target serving cell scheduled by the DCI; and
when the codepoint information corresponding to the target bitfield is the second indication information, determine a serving cell indicated to be scheduled by the second indication information as the target serving cell scheduled by the DCI.

It can be understood that the implementation principle and manner of the apparatus 80 for processing downlink control information described above are the same as those of the method for processing downlink control information described in FIG. 2, so the descriptions of various embodiments of the method for processing downlink control information applied to UE can be referred to, which will not be repeated here.

Based on the content described in the above embodiments, referring to FIG. 9, FIG. 9 is a second schematic diagram of a program module of an apparatus for processing downlink control information provided by an embodiment of the present disclosure. An executive subject of the present embodiment is the network device in the embodiment shown in FIG. 1. As shown in FIG. 9, in another possible embodiment of the present disclosure, the above apparatus 90 for processing downlink control information includes:
a determining module 901, configured to determine a target serving cell scheduled by DCI;
a processing module 902, configured to configure, according to the target serving cell, a CIF value in the DCI and a configuration parameter of a first serving cell corresponding to the CIF value in the target serving cell, where the configuration parameter includes one or more serving cell indexes; or, configure, according to the target serving cell, codepoint information corresponding to a target bitfield in the DCI, where the codepoint information is used to indicate scheduling information of one or more schedulable serving cell; and
a sending module 903, configured to send the configured DCI to the UE.

According to the apparatus 90 for processing downlink control information provided by the embodiment of the present disclosure, when the DCI needs to schedule a plurality of serving cells at the same time, a network device can configure codepoint information corresponding to a target bitfield in the DCI, the configured codepoint information can be used to indicate one or more schedulable serving cells, by which a DCI format also does not need to be changed, thereby without the DCI format needing to be changed, the UE is enabled to, after receiving the DCI, accurately parse the plurality of serving cells scheduled by the DCI according to the codepoint information corresponding to the target bitfield in the DCI.

In a possible implementation, the processing module 902 is configured to:
determine a CIF value corresponding to the first serving cell in the target serving cell; and configure the CIF value in the DCI according to the CIF value corresponding to the first serving cell in the target serving cell, and configure the configuration parameter of the first serving cell according to the number of the target serving cell.

In a possible implementation, the processing module 902 is configured to:
when other serving cells exist in the target serving cell in addition to the first serving cell, add a serving cell index of the other serving cells in addition to the first serving cell to the configuration parameter of the first serving cell.

In a possible implementation, the codepoint information corresponding to the target bitfield in the DCI includes first indication information and second indication information, and the number of serving cells indicated to be scheduled by the first indication information and the second indication information are different; the processing module 902 is configured to:
configure, according to the number of the target serving cells, codepoint information of respective bitfields in the DCI as the first indication information or the second indication information.

It can be understood that the implementation principle and manner of the apparatus 90 for processing downlink control information described above are the same as those of the method for processing downlink control information described in FIG. 3, so the descriptions of various embodiments of the method for processing downlink control information applied to UE can be referred to, which will not be repeated here.

In an embodiment, the apparatus can be a chip or a chip module, etc.

As for each module included in the apparatus in the above embodiments, it can be a software module, a hardware module, or a part of a software module and a part of a hardware module. For example, for each apparatus or product applied to or integrated in a chip, all the modules contained in it can be realized in the form of hardware such as circuits, or at least some modules can be realized in the form of software programs, which run on a processor integrated in the chip, and the remaining (if any) modules can be realized in the form of hardware such as circuits; for each apparatus and product applied to or integrated in a chip module, each module contained therein can be realized by hardware means such as circuits, and different modules can be located in a same component (e.g. chip, circuit module, etc.) or different components of the chip module, or at least some modules can be realized by software programs, which run on a processor integrated in the chip module, and the remaining (if any) modules can be realized by hardware means such as circuits; for each apparatus and product applied to or integrated in a terminal, the modules contained therein can all be realized in the form of hardware such as circuits, and different modules can be located in a same component (e.g., chips, circuit modules, etc.) or different components in the terminal, or at least some modules can be realized in the form of software programs, which run on the processor integrated in the terminal, and the remaining (if any) modules can be realized in the form of hardware such as circuits.

Further, based on the content described in the above embodiments, an embodiment of the present disclosure further provides a user equipment, where the user equipment includes at least one processor and a memory; where the memory is configured to store a computer-executable instruction; the at least one processor is configured to execute the computer-executable instruction stored in the memory, so as to implement the content as described in the embodiments of the method for processing downlink control information applied to the UE.

Further, based on the content described in the above embodiments, an embodiment of the present disclosure further provides a network device, where the network device includes at least one processor and a memory; where the memory is configured to store a computer-executable instruction; the at least one processor is configured to execute the computer-executable instruction stored in the memory, so as to implement the content as described in the embodiments of the method for processing downlink control information applied to the network device.

The user equipment and the network device provided in the present embodiment can be used to implement the technical solution of the above method embodiments, and their implementation principles and technical effects are similar, which will not be repeated here in the present embodiment.

For better understanding of the embodiments of the present disclosure, referring to FIG. 10, FIG. 10 is a schematic hardware structural diagram of an electronic device provided by an embodiment of the present disclosure. The electronic device may the above user equipment, or may be the above network device.

As shown in FIG. 10, the electronic device 100 of the present embodiment includes: a processor 1001 and a memory 1002; where
the memory 1002 is configured to store a computer-executable instruction; and
the processor 1001 is configured to execute the computer-executable instruction stored in the memory 1002 so as to implement respective steps performed by the user equipment in the above embodiments, and details can be referred to from the related description in the previous method embodiments;
or the processor 1001 is configured to execute the computer-executable instruction stored in the memory so as to implement respective steps performed by the network device in the above embodiments, and details can be referred to from the related description in the previous method embodiments.

In an embodiment, the memory 1002 may be independent or integrated with the processor 1001.

When the memory 1002 is independently set, the device further includes a bus 1003 for connecting the memory 1002 and the processor 1001.

An embodiment of the present disclosure provides a computer readable storage medium, storing a computer-executable instruction, where when a processor executes the computer-executable instruction, respective steps performed by the user equipment in the above embodiments are implemented.

An embodiment of the present disclosure provides a computer readable storage medium, storing a computer-executable instruction, where when a processor executes the computer-executable instruction, respective steps performed by the network device in the above embodiments are implemented.

In several embodiments provided by the present disclosure, it should be understood that the disclosed devices and methods can be implemented in other manners. For example, the device embodiments described above are only schematic. For example, division of modules is only a division of logical functions. In actual implementation, there may be other division manners, such as multiple modules can be combined or integrated into another system, or some features can be ignored or not implemented. On the other hand, the mutual coupling or direct coupling or communication connection shown or discussed can be indirect coupling or communication connection through some interfaces, apparatuses or modules, which can be electrical, mechanical or in other forms.

The modules described as separate components may or may not be physically separated, and the components displayed as modules may or may not be physical units, that is, they may be located in one place or distributed to a plurality of network units. Some or all of the modules can be selected according to actual needs to achieve the purpose of the present embodiment.

In addition, each functional module in each embodiment of the disclosure can be integrated into one processing unit, or each module can exist physically alone, or two or more modules can be integrated into one unit. The above-mentioned modular units can be realized in the form of hardware, or in the form of hardware plus software functional units.

The above-mentioned integrated modules realized in the form of software functional modules can be stored in a computer readable storage medium. The above software function module is stored in a storage medium, and includes several instructions to cause a computer device (may be a personal computer, a server, or a network device, etc.) or a processor (English: processor) to execute part of the steps of the method described in various embodiments of the present disclosure.

It should be understood that the above processor may be a central processing unit (CPU), or other general processors, digital signal processors (DSP), application specific integrated circuits (ASIC), etc. The general processor may be a microprocessor or the processor can be any ordinary processor, etc. The steps of the method disclosed with reference to the present disclosure can be directly embodied to be executed and completed by a hardware processor, or to be executed and completed by a combination of hardware and software modules in the processor.

The memory may include high-speed RAM memory, or may further include non-volatile storage NVM, such as at least one disk memory, or may also be a U disk, a mobile hard disk, a read-only memory, a magnetic disk or an optical disk, etc.

The bus can be an industry standard architecture (ISA) bus, a peripheral device interconnection (Peripheral Component, PCI) bus or an extended industry standard architecture (EISA) bus, etc. The bus can be divided into an address bus, a data bus and a control bus, etc. For the convenience of description, the bus in the drawings of the present disclosure is not limited to only one bus or one type of bus.

The above storage medium can be realized by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk. The storage medium may be any available medium that can be accessed by a general-purpose or special-purpose computer.

An exemplary storage medium is coupled to a processor so as to cause the processor to read information from and write information into the storage medium. Certainly, the storage medium may also an integral part of the processor. The processor and the storage medium may be located in an application specific integrated circuit (ASIC). Certainly, the processor and the storage medium may also exist as separate components in an electronic device or a main control device.

It can be understood by those skilled in the art that all or part of the steps for implementing the above method embodiments can be completed by hardware related to program instructions. The above mentioned program may be stored in a computer readable storage medium. When the program is executed, the steps of the above method embodiments are performed; the above mentioned storage medium includes: a ROM, a random access memory (RAM), a magnetic disk or an optical disk and other media that can store program codes.

Embodiments of the present disclosure provide a method and device for processing downlink control information, which may enable a UE to accurately parse a plurality of serving cells scheduled by DCI without changing a DCI format when the DCI schedules the serving cells at the same time.

In a first aspect, an embodiment of the present disclosure provides a method for processing downlink control information, applied to a UE and including:
receiving DCI sent by a network device;
determining a first serving cell according to a carrier indicator field (CIF) value in the DCI, and determining a target serving cell scheduled by the DCI according to a configuration parameter of the first serving cell, where the configuration parameter includes one or more serving cell indexes; or,
determining, according to codepoint information corresponding to a target bitfield in the DCI, scheduling information of the target serving cell scheduled by the DCI, where the codepoint information corresponding to the target bitfield is used to indicate scheduling information of one or more schedulable serving cells.

In a possible design, the determining the first serving cell according to the CIF value in the DCI includes:
determining a schedulable serving cell in the respective schedulable serving cells that have a CIF value same as the CIF value in the DCI as the first serving cell.

In a possible design, the determining the target serving cell scheduled by the DCI according to the configuration parameter of the first serving cell includes:
detecting whether other target serving cell indexes exist in the configuration parameter of the first serving cell in addition to a serving cell index of the first serving cell;
if other target serving cell indexes exist in the configuration parameter of the first serving cell in addition to the serving cell index of the first serving cell, determining the first serving cell and a schedulable serving cell corresponding to the target serving cell index as the target serving cell scheduled by the DCI; and
if no other target serving cell index exist in the configuration parameter of the first serving cell in addition to the serving cell index of the first serving cell, determining the first serving cell as the target serving cell scheduled by the DCI.

In a possible design, before the determining, according to the codepoint information corresponding to the target bitfield in the DCI, the scheduling information of the target serving cell scheduled by the DCI, the method includes:
determining configuration information corresponding to the respective schedulable serving cells, where the configuration information includes a scheduling relationship between the codepoint information corresponding to the target bitfield in the DCI and the respective schedulable serving cells; where the codepoint information corresponding to the target bitfield includes first indication information and second indication information, and the number of serving cells indicated to be scheduled by the first indication information and the second indication information are different.

In a possible design, before the determining, according to the codepoint information corresponding to the target bitfield in the DCI, the scheduling information of the target serving cell scheduled by the DCI, the method includes:
when the codepoint information corresponding to the target bitfield is the first indication information, determining a serving cell indicated to be scheduled by the first indication information as the target serving cell scheduled by the DCI; and
when the codepoint information corresponding to the target bitfield is the second indication information, determining a serving cell indicated to be scheduled by the second indication information as the target serving cell scheduled by the DCI.

In a second aspect, an embodiment of the present disclosure provides a method for processing downlink control information, applied to a network device and including:
determining a target serving cell scheduled by DCI;
configuring, according to the target serving cell, a CIF value in the DCI and a configuration parameter of a first serving cell corresponding to the CIF value in the target serving cell, where the configuration parameter includes one or more serving cell indexes; or, configuring, according to the target serving cell, codepoint information corresponding to a target bitfield in the DCI, where the codepoint information is used to indicate scheduling information of one or more schedulable serving cells; and
sending the configured DCI to a UE.

In a possible design, the configuring, according to the target serving cell, the CIF value in the DCI and the configuration parameter of the first serving cell corresponding to the CIF value in the target serving cell includes:
determining a CIF value corresponding to the first serving cell in the target serving cell; and
configuring the CIF value in the DCI according to the CIF value corresponding to the first serving cell in the target serving cell, and configuring the configuration parameter of the first serving cell according to the number of the target serving cell.

In a possible design, the configuring the configuration parameter of the first serving cell according to the number of the target serving cell includes:
when other serving cells exist in the target serving cell in addition to the first serving cell, adding a serving cell index of the other serving cells in addition to the first serving cell to the configuration parameter of the first serving cell.

In a possible design, the codepoint information corresponding to the target bitfield in the DCI includes first indication information and second indication information, and the number of serving cells indicated to be scheduled by the first indication information and the second indication information are different;
the configuring, according to the target serving cell, the codepoint information corresponding to the target bitfield in the DCI includes:
configuring, according to the number of the target serving cells, codepoint information of respective bitfields in the DCI as the first indication information or the second indication information.

In a third aspect, an embodiment of the present disclosure provides an apparatus for processing downlink control information, applied to a UE and including:
a receiving module, configured to receive DCI sent by a network device; and
a processing module, configured to determine a first serving cell according to a CIF value in the DCI, and determine a target serving cell scheduled by the DCI according to a configuration parameter of the first serving cell, where the configuration parameter includes one or more serving cell indexes; or,
determine, according to codepoint information corresponding to a target bitfield in the DCI, scheduling information of the target serving cell scheduled by the DCI, where the codepoint information corresponding to the target bitfield is used to indicate scheduling information of one or more schedulable serving cells.

In a fourth aspect, an embodiment of the present disclosure provides an apparatus for processing downlink control information, applied to a network device and including:
a determining module, configured to determine a target serving cell scheduled by DCI;
a processing module, configured to configure, according to the target serving cell, a CIF value in the DCI and a configuration parameter of a first serving cell corresponding to the CIF value in the target serving cell, where the configuration parameter includes one or more serving cell indexes; or, configure, according to the target serving cell, codepoint information corresponding to a target bitfield in the DCI, where the codepoint information is used to indicate scheduling information of one or more schedulable serving cells; and
a sending module, configured to send the configured DCI to a UE.

In a fifth aspect, an embodiment of the present disclosure provides a user equipment, including: at least one processor and a memory;
where the memory is configured to store a computer-executable instruction; and
the at least one processor is configured to execute the computer-executable instruction stored in the memory to cause the at least one processor to perform the method for processing the downlink control information according to the first aspect.

In a sixth aspect, an embodiment of the present disclosure provides a network device, including: at least one processor and a memory;
where the memory is configured to store a computer-executable instruction; and
the at least one processor is configured to execute the computer-executable instruction stored in the memory to cause the at least one processor to perform the method for processing the downlink control information according to the second aspect.

In a seventh aspect, an embodiment of the present disclosure provides a computer readable storage medium, storing a computer-executable instruction, where when a processor executes the computer-executable instruction, the method for processing the downlink control information according to the first aspect is implemented;
or, when a processor executes the computer-executable instruction, the method for processing the downlink control information according to the second aspect is implemented.

According to the method and device for processing downlink control information provided by the embodiments of the present disclosure, when DCI needs to schedule a plurality of serving cells at the same time, a network device can configure serving cell indexes of a plurality of serving cells in a configuration parameter of a first serving cell scheduled by the DCI at the same time, and without a DCI format needing to be changed, the UE is enabled to, after receiving the DCI, accurately parse the plurality of serving cells scheduled by the DCI according to the configuration parameter of the first serving cell; or, when the DCI needs to schedule the plurality of serving cells at the same time, the network device can configure codepoint information corresponding to a target bitfield in the DCI, the configured codepoint information can be used to indicate scheduling information of one or more schedulable cells, thereby without the DCI format needing to be changed, the UE is enabled to, after receiving the DCI, accurately parse the scheduling information of the plurality of serving cells scheduled by the DCI according to the codepoint information corresponding to the target bitfield in the DCI.

Finally, it should be noted that: the above embodiments are only used to illustrate the technical solution of the present disclosure, but not to limit it; although the present disclosure has been described in detail with reference to the above mentioned embodiments, it should be understood by those skilled in the art that the technical solution described in the above mentioned embodiments can still be modified, or some or all of its technical features can be replaced by equivalents; however, these modifications or substitutions do not make the essence of the corresponding technical solutions deviate from the scope of the technical solutions of various embodiments of the present disclosure.

1-14. (canceled)

15. A method for processing downlink control information, applied to a network device and comprising:
determining one or more target serving cells scheduled by downlink control information (DCI);
in response to multiple target serving cells being scheduled, configuring codepoint information corresponding to a target bitfield of the DCI, wherein the codepoint information is used to indicate scheduling information of the multiple target serving cells;
sending the DCI to a user equipment (UE).

16. The method according to claim 15, wherein the configuring the codepoint information corresponding to the target bitfield of the DCI comprises:
obtaining a schematic table of a scheduling relationship between the codepoint information and the multiple target serving cells;
determining index of the codepoint information based on the schematic table of the scheduling relationship.

17. The method according to claim 16, wherein an index of the codepoint information is used to indicate that the scheduling information of each target serving cells are different.

18. The method according to claim 17, wherein the index of the codepoint information is 0 and the DCI only comprises the scheduling information of cell 1.

19. The method according to claim 16, wherein another index of the codepoint information is used to indicate that the scheduling information of each target serving cells are same.

20. The method according to claim 19, wherein the index of the codepoint information is 1 and the DCI comprises the scheduling information of cell 0 and cell 1.

21. The method according to claim 15, wherein the codepoint information comprises first indication information and second indication information, wherein the first indication information and the second indication information indicate the number of the target serving cells is different.

22. The method according to claim 15, wherein a length of the DCI for scheduling one serving cell is the same as a length of the DCI for scheduling two serving cells.

23. A network device, comprising: at least one processor and a memory;
wherein the memory is configured to store a computer-executable instruction; and
the at least one processor is configured to execute the computer-executable instruction stored in the memory to cause the at least one processor to:
determine one or more target serving cells scheduled by downlink control information (DCI);
in response to multiple target serving cells being scheduled, configure codepoint information corresponding to a target bitfield of the DCI, wherein the codepoint information is used to indicate scheduling information of the multiple target serving cells;
send the DCI to a user equipment (UE).

24. The network device according to claim 23, wherein the at least one processor is configured to execute the computer-executable instruction stored in the memory to cause the at least one processor to:
obtain a schematic table of a scheduling relationship between the codepoint information and the multiple target serving cells;
determine index of the codepoint information based on the schematic table of the scheduling relationship.

25. The network device according to claim 24, wherein an index of the codepoint information is used to indicate that the scheduling information of each target serving cells are different;
wherein the index of the codepoint information is 0 and the DCI only comprises the scheduling information of cell 1.

26. The network device according to claim 24, wherein another index of the codepoint information is used to indicate that the scheduling information of each target serving cells are same;
wherein the index of the codepoint information is 1 and the DCI comprises the scheduling information of cell 0 and cell 1.

27. The network device according to claim 23, wherein the codepoint information comprises first indication information and second indication information, wherein the first indication information and the second indication information indicate the number of the target serving cells is different.

28. The network device according to claim 23, wherein a length of the DCI for scheduling one serving cell is the same as a length of the DCI for scheduling two serving cells.

29. A non-transitory computer readable storage medium, storing a computer-executable instruction, wherein at least one processor, when executing the computer-executable instruction, is configured to:
determine one or more target serving cells scheduled by downlink control information (DCI);
in response to multiple target serving cells being scheduled, configure codepoint information corresponding to a target bitfield of the DCI, wherein the codepoint information is used to indicate scheduling information of the multiple target serving cells;
send the DCI to a user equipment (UE).

30. The non-transitory computer readable storage medium according to claim 29, wherein the at least one processor is configured to:
obtain a schematic table of a scheduling relationship between the codepoint information and the multiple target serving cells;
determine index of the codepoint information based on the schematic table of the scheduling relationship.

31. The non-transitory computer readable storage medium according to claim 30, wherein an index of the codepoint information is used to indicate that the scheduling information of each target serving cells are different;
wherein the index of the codepoint information is 0 and the DCI only comprises the scheduling information of cell 1.

32. The non-transitory computer readable storage medium according to claim 30, wherein another index of the codepoint information is used to indicate that the scheduling information of each target serving cells are same;
wherein the index of the codepoint information is 1 and the DCI comprises the scheduling information of cell 0 and cell 1.

33. The non-transitory computer readable storage medium according to claim 29, wherein the codepoint information comprises first indication information and second indication information, wherein the first indication information and the second indication information indicate the number of the target serving cells is different.

34. The non-transitory computer readable storage medium according to claim 29, wherein a length of the DCI for scheduling one serving cell is the same as a length of the DCI for scheduling two serving cells.
